(19) United States
(12) Patent Application Publication
(10) Pub. No.: US 2006/0288057 A1
(43) Pub. Date: Dec. 21, 2006

(54) Portable data backup appliance

(76) Inventors: Ian Collins, Markham (CA); Eric Li, Agincourt (CA)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/154,088

(22) Filed: Jun. 15, 2005

(51) Int. Cl. G06F 17/30

(52) U.S. Cl. 707/204

(57) ABSTRACT

An appliance and method for simply and regularly backing up data files of a predetermined file type from a source device. The appliance is adapted for initiating a backup operation in response to only a single action being performed by a user.

### FIELD OF THE INVENTION

The invention relates to data storage, and more particularly to backup devices.

### BACKGROUND OF THE INVENTION

The number of digital data generating devices has increased dramatically in recent years and is expected to continue to grow significantly in the future. With this rise, there has been an attendant increase in digital data. In private households and in businesses, there are increasingly large collections of digital data, in the form of music collections, digital photo collections, saved email messages, and others. Where PC storage space was once too scarce and expensive to keep large collections of digital data, the cost of PC storage space has dramatically decreased and data stored on PCs has proliferated.

Digital photos stored on a PC have replaced shoeboxes full of family photos. MP3 music collections have displaced shelves of CDs or vinyl. Digital video and PVR-recorded television are poised to replace videotape collections.

However, the digital revolution in data has swept through faster than storage options have been able to mature. PC storage has notorious vulnerabilities. Almost everyone who owns a PC has experienced a massive computer failure at one point. The wisdom of wiping a hard-drive and re-installing the operating system may be sensible for overcoming such technical difficulties, but such a resolution also tends to destroy everything else on hard-drive, including the digital data.

Existing backup solutions, developed mostly for business applications, are expensive, bulky and overly complicated. A need exists for an extremely simple, fully automated, and affordable storage appliance designed for the non-technical consumer mass market for digital data collections. Without limiting such solutions to consumers, the desired level of simplicity and affordability should be accessible to consumers, including consumers that are not necessarily technologically sophisticated.

It would also be desirable to provide a single-purpose storage solution, which would be specially tailored to accommodate the storage requirements of a particular type or class of data. The storage appliance could be used simply and regularly to back up specific file types, then, for maximum protection, could be removed to another physical location away from the source to protect from robbery, fire, and other threats. Preferably, the storage appliance would use a long term extremely reliable storage media that will have a long life.

### SUMMARY OF THE INVENTION

The invention provides a portable single purpose data backup appliance.

As used herein, “data” means any type of information in human or machine readable format. Digitally-encoded data is the preferred form, but is not intended to limit the definition of data.

“Data file” means any string or collection of data in a file, and includes any headers, comments, metadata, properties, time/date markings (such as the date the file was created), settings, and any associated sub-files. Depending on the context, “data file” may also include the location of the data file in original source.

“Type of data file” or “file type” means any identifiable type or class of types of files. For example, “music files” may be a “file type”, which refers to all types of audio files (including, for example, files having .wav, .mp3, and other file extensions).

According to a first aspect of the invention, a method is provided for simply and regularly backing up data files of a predetermined file type by a backup appliance in communication with a source device. The backup appliance is preferably fully automated single purpose, portable, and detachable. Preferably, the method comprises:

in response to only a single action being performed by a user with respect to the appliance, the appliance sending a request to the source device to identify, independently of the user, any files of the predetermined file type; and for each file identified performing a backup operation.

Preferably, the backup operation comprises:

checking whether the file has previously been stored; and

if not previously stored, storing the file on the appliance by creating a copy.

The method may further comprise setting a timer on the computer to perform the backup operation, automatically and without further input by the user, after a predetermined period of time. The method may also further comprise performing at predetermined intervals a self-diagnostic routine without further input by the user.

Preferably, the single action performed to trigger the backup operation comprises connecting the storage appliance to the source device. Alternatively, the single action may comprise pushing a button on the storage appliance.

Preferably, the appliance is configured to identify and backup files of a predetermined file type. Preferably, the file type is a single file type selected from the group consisting of: an image file type, a music file type, an email file type, a business application data file type (such as Accpac™ or Simply Accounting™ files), a digital video file type, an ebook file type, a contacts file type, a calendar file type, a general documents file type, a tasks file type, a settings file type, an application data file type, a bookmarks file type, and a passwords file type. For greater certainty, a “file type” is not restricted to one type of file extension, but may include identifiable files of a particular class or group of file extensions. Alternatively, the appliance may be configured for backing up files of two specific file types, such as a combination of “music” and “picture” file types. Importantly, the appliance is “purpose-built” for backing up a particular file type or combination of file types, rather than providing a complete or “image” backup of an entire data source.

Files may also be recognized that are attached to or embedded with other files, documents or applications. For instance, image files attached to an email message may be searched for and backed-up by the appliance. Similarly, the appliance may detect files of the predetermined file type(s) embedded within another file, such as a zip archive file.

For instance, the file type may be an image file type, such as a digital photograph image file type.

Preferably, the method further comprises keeping a map on the appliance of drive and directory location indicating the source of each file on the source device (also known as a file path or directory structure).

Preferably, the method requires no installation of software on the source device to perform the backup operation.

According to a second aspect of the invention, a fully automated single purpose, portable, detachable backup appliance is provided for backup according to the method previously set out.

Preferably, the appliance comprises a single-purpose storage device adapted exclusively for storage of the predetermined file type.

The appliance may be reliant upon the power of the source device, or it may have an onboard power supply (such as one or more batteries). Still further, the appliance may use an external power supply (non- battery).

Preferably, the appliance has a form factor adapted for portability.

Preferably, the appliance has no display and has limited user controls.

Communication between the appliance and the source device may be wired or wireless.

Preferably, the appliance includes a built-in cable for interface with the source device The cable may be any standard or custom interface cable, and may be a USB cable or Firewire cable.

Preferably, the appliance is adapted to interface with a single type of source device. The source device may comprise a computer. However, the source device may comprise any single device with storage capabilities that might require a simple method of backup, selected from the group consisting of: a PC, a PVR, a cellphone, a home electronic device, a digital camera, a PDA, a digital video camera, a scanner, a digital music player, a digital video player, a game console, and a storage file server.

### BRIEF DESCRIPTION OF THE FIGURES

In order to illustrate preferred embodiments of the invention, a set of drawings is provided in which:

FIG. 1 shows a flow diagram of the preferred embodiment of the backup method and associated process for recovery.

FIG. 2A shows a front view of the appliance according to the preferred embodiment.

FIG. 2B shows a back view of the appliance.

FIG. 2C shows a view of an illustrative power adapter for use with the appliance.

FIG. 2D shows a top view of the appliance (the bottom view being identical thereto).

FIG. 2E shows a perspective side view of the appliance with power adapted and data cable.

FIG. 2F shows a view of an illustrative data cable for use with the appliance.

FIG. 3 shows a diagram of the appliance in connection with illustrative source device (PC, shown) with illustrative data and power cables.

FIG. 4 shows a sample screen diagram of an initialization step according to the preferred embodiment of the method (in response to a single action).

FIG. 5 shows a sample screen diagram of a file searching step.

FIG. 6 shows a sample screen diagram of backing up of found files to the appliance.

FIG. 7 shows a sample end screen (backup complete).

FIG. 8 shows a sample screen diagram detecting connection to a different source device (data from another source on appliance already).

### DETAILED DESCRIPTION

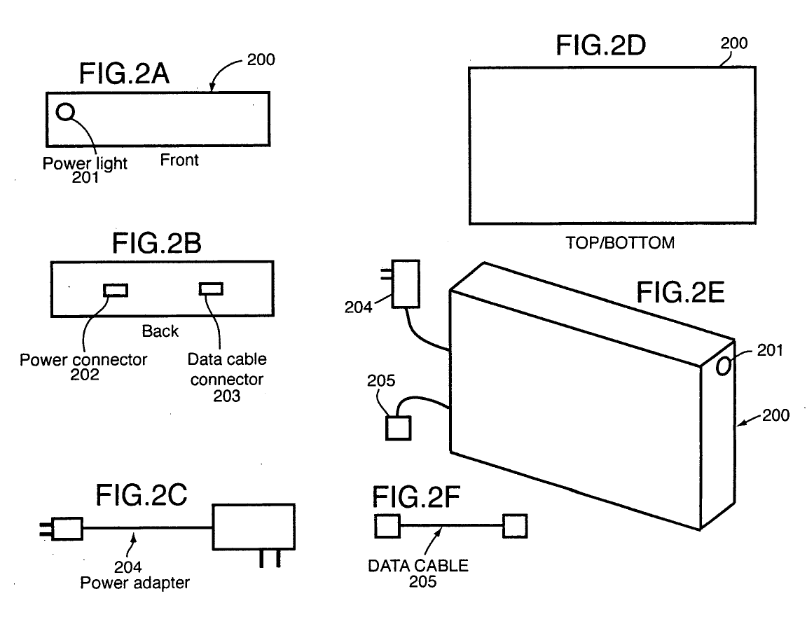

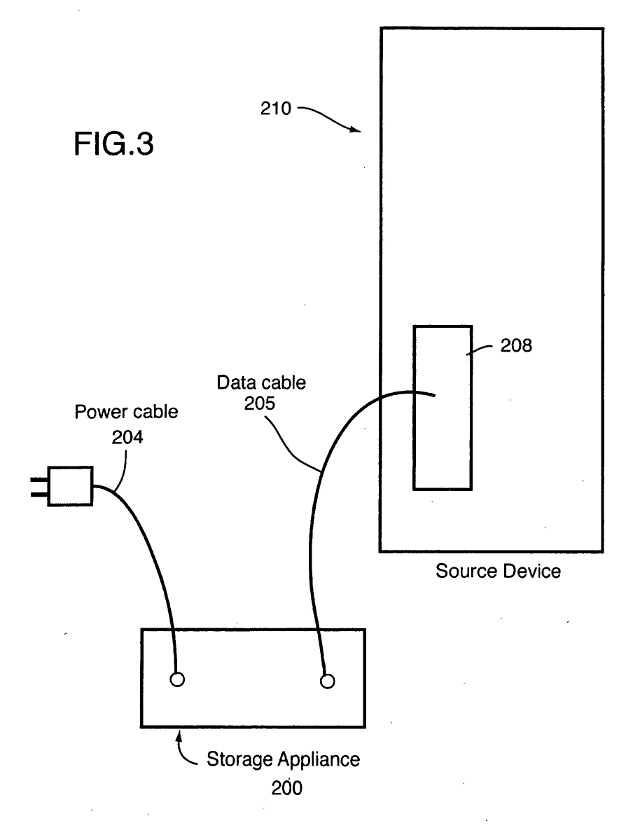

A preferred embodiment of the appliance 200 is shown in FIG. 3. As shown, a source device 210 containing files is connected to the appliance 200 for backup of the predetermined file type. For instance, the file type may be music files (in .mp3, .wav, or other audio file extensions). Preferably, the appliance is portable, robust physical construction. Form factor is preferably within the range of portability (approximately 3 lbs or less). As shown, the appliance preferably has minimal input and output capability. While a display on the appliance is not excluded, the preferred embodiment has no display of its own (thus making the appliance simpler and more physically robust). Preferably, a data cable 205 connects the appliance 200 to a port 208 on the source device. The appliance 200 also preferably has a power cable (or adapter) 204 for connection to AC (or equivalent) power source. The cables are preferably receivable in suitable connection ports 202, 203 on the appliance 200. As shown in FIGS. 2A and 2E, the appliance may also include a “power light” 201 showing that the appliance 200 is connected to an external power source (or has a working battery).

As shown in the Figures, the physical shape of the appliance 200 may be a simple box. Other physical configurations are possible with the overriding consideration that the appliance be portable and convenient for use.

Without limitation, but strictly to illustrate one possible configuration, the appliance may include a storage component having approximately 20-60 GB in capacity; such as a 2.5″ or 3.5″ hard disk drive. The appliance may include on-board RAM, and an on-board processor. However, for simplicity and decreased manufacturing cost, the appliance could be designed simply to employ the processing and RAM capability of the source device.

The appliance is preferably powered by on-board or external battery, AC via an AC adapter, or source device powered (or a combination of any of these).

The communication with the source device is preferably via wireless, Firewire or USB. Preferably, all software required to perform all functions will be resident on the appliance's hard disk drive.

There may be a practical minimum limit on the size of the appliance. Even as memory media becomes physically smaller, it may be desirable to keep the appliance above a certain minimum physical size to facilitate handling and long-term storage.

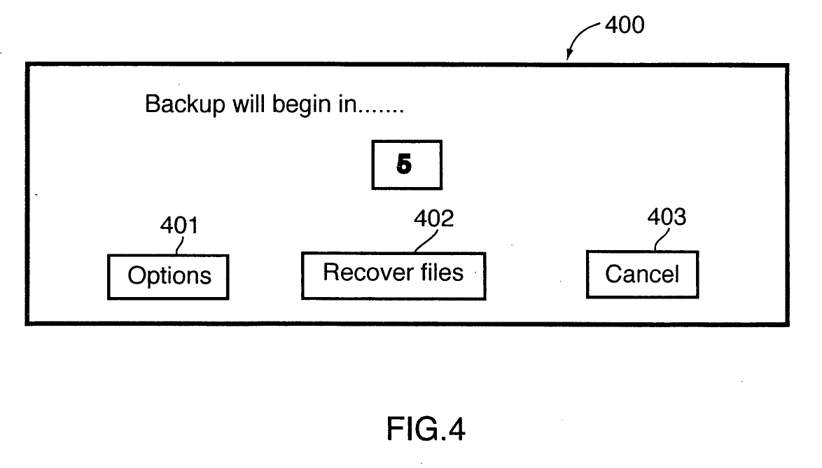

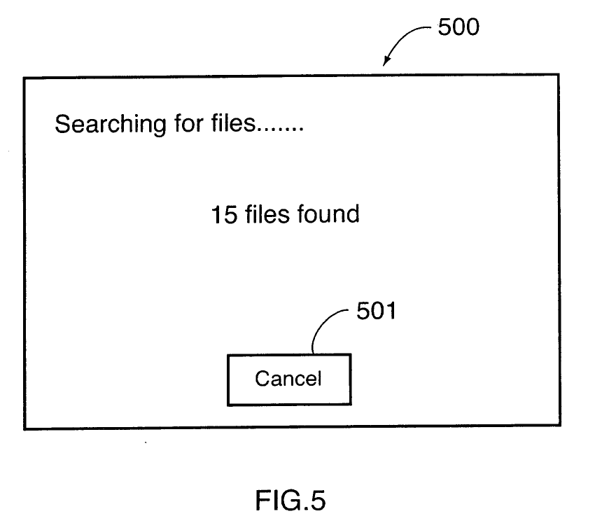

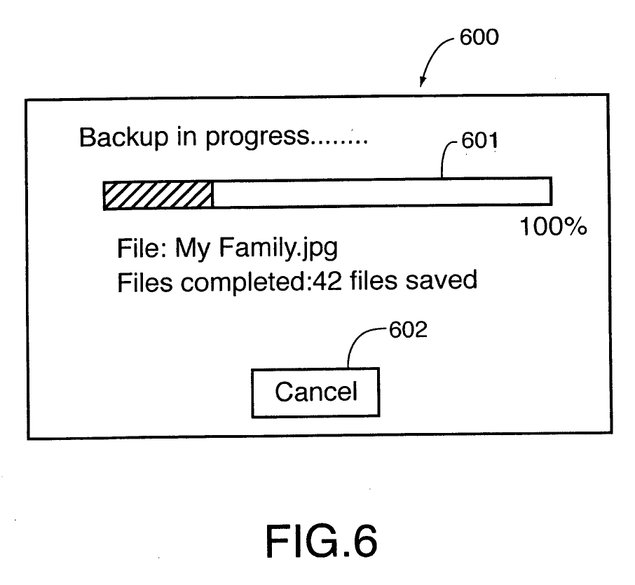

In operation, the appliance is fully automated for normal backup. Preferably, to begin backup, the appliance 200 is plugged in to the source device 210 (as shown in FIG. 3). (Upon detecting the connection, an association process occurs within the appliance to check whether there is any pre-existing data on the appliance, and if so, whether this data is associated with the device now connected. This process is described in further detail below.) After a timed delay (FIG. 4), the appliance will automatically begin to search for files of that type on the source device (see FIG. 5). This timer is designed to give the user enough time to decide whether to let the system backup the files (the default action, in the absence of further input), or to request that the appliance start the recovery process instead. No backup or searching will occur while the timer is counting down. Searching occurs in FIG. 5, and backup in FIG. 6.

As shown in FIG. 5, a scrolling number of found files 500 may be displayed on the source device once searching has begun. Once all files have been located, the backup operation begins. (If no files of the predetermined type are located, no backup occurs.) As shown in FIG. 6, the progress of the backup 600 may be displayed on the source device. The display may also indicate the name of the file currently being backed up.

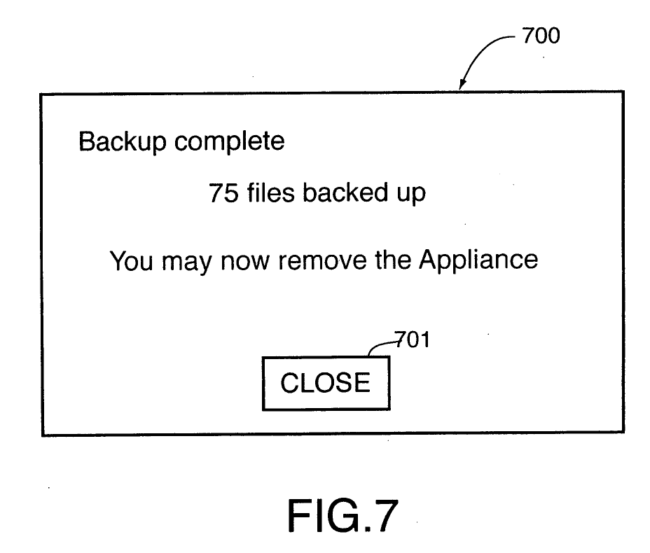

On completion, the number of files backed up 700 may be displayed with a completion message, as shown in FIG. 7. No input of any kind is required by the user for the progress of the backup. However, as shown in the Figures, there may be options 401 for configuring the backup, or for canceling the operation 403, 501, 602 at various stages. Importantly, in the absence of user input, the backup will proceed on a default basis, unless an error condition is encountered (not shown). It is intended that the appliance should be able to operate on a “set it and forget it” basis, as a feature of the simplicity of the appliance.

To begin the backup operation, a single action is required from the user. Preferably, this single action is the establishing of a physical (or wireless) connection between the appliance and the source device (as shown in FIG. 3). However, other single action triggers are possible. For instance, the user may push a button on the appliance to begin backup operation (not shown), or the appliance may be lodged in a cradle (not shown). A single action may also be invoked from the source device, as an alternative.

Preferably, the operability of the appliance is ready “out of the box”. Preferably, the appliance does not require any user configuration or program installation (or download to the source device) to operate.

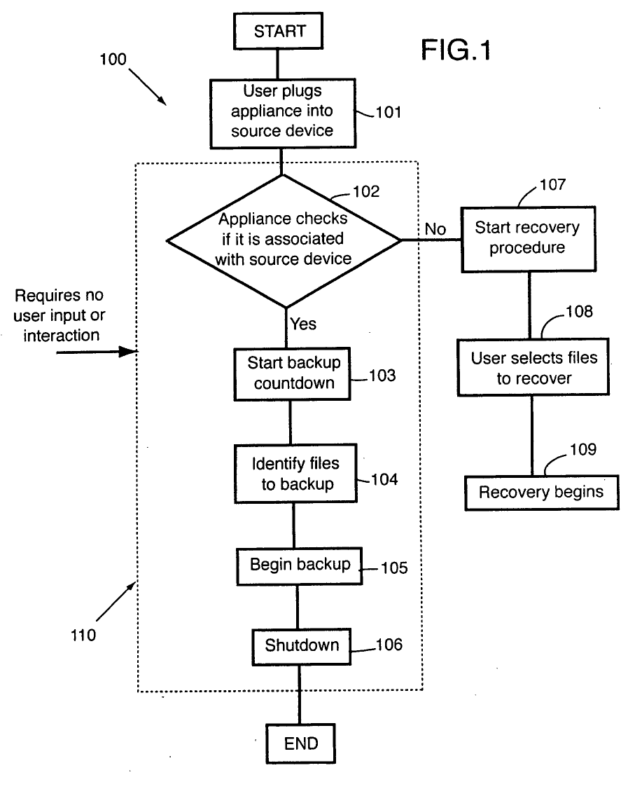

Turning to the flow diagram in FIG. 1, the preferred method 100 employed by the appliance is illustrated in more detail. After plugging the appliance into the source device 101, the appliance checks if it is “associated with” or “recognizes” the source device 102.

In its simplest incarnation, the storage appliance may be programmed to backup one source device only (in more sophisticated embodiments, the appliance may backup multiple source devices). Each storage appliance will place a marker on the device after the first backup session, so that the appliance will “recognize” that device when doing subsequent backups. In the single-device backup appliance, if the source device is not “recognized” as having a marker, but there is already data stored on the appliance, the appliance will assume the user wants to restore.

If a marker is detected, the default operation will be to start the backup procedure (unless manually directed to restore by the user, or manually cancelled). If no marker is detected, the appliance will assume that the user has a new source device or has erased the old one. In this case, the default will be to provide a menu of options to the user, to either recover the data that exists in the appliance to this “new” source, or backup the new source. This association check is therefore independent of the hardware itself (a clean old source device may be treated the same as a new source device). If the appliance contains no data at all, there will be an assumption that the appliance is not associated, but since there is no data on it, there is nothing to recover. As a result, the appliance will proceed directly to backup mode instead of providing the option to recover.

Provided that the source device is recognized, the backup operation will automatically begin 103 after a countdown (also shown in FIG. 4). The files to backup are identified from the source device 104 (display shown in FIG. 5). The process for identifying involves searching the source device and identifying the files, based on file type. The appliance may also be programmed to specifically include/exclude specific directories and drives (locations) on the source device. For example, on a Windows PC, the appliance may be programmed to skip the Internet Explorer directory. Once the files of the predetermined type are identified, the actual backup begins 105 (display shown in FIG. 6). The identified files are at this point copied onto the storage appliance. In the process of copying files, the application running on the source device may temporarily store all file names before backing up to the storage appliance, but this is one implementation only, it may not be the same in all cases. After backup is complete, a completion message may be displayed (as shown in FIG. 7) and the process shuts down 106. Optionally, the appliance may be programmed to re-start 103 the file identification and backup steps automatically after a predetermined time interval, or upon the occurrence of some other automatic trigger (such as the number of files that have been identified as not yet backed up), provided that the connection between the appliance and the source device remains intact.

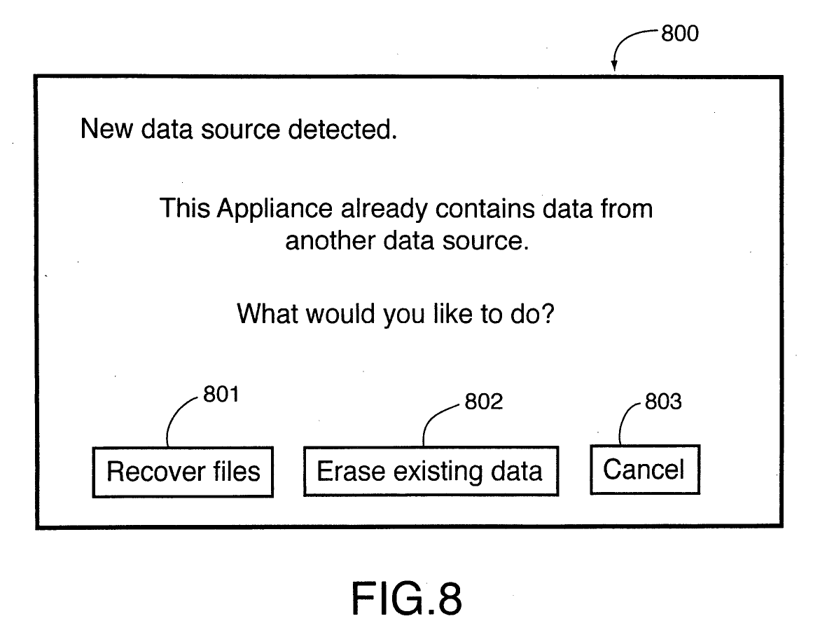

If at the initial “checking” step 102, the appliance does not find the expected “marker” on the source device (see display at FIG. 8), the appliance may move to an option allowing the user to start a recovery procedure 107 (option also shown in FIG. 4 at 402). For recovery, the user may be led through a series of simple screens (not shown) to identify which files to restore 108, and recovery of those files begins 109. The user may elect instead to erase files previously backed up without restoring (see option 802) (which prepares the appliance to backup a new source device automatically)

The recovery process allows files to be restored to the original source device (or another source device, or both), preferably in the same location (drive, pathname, etc.) as at the time of backup. Files are preferably restored with all metadata, properties, etc. intact.

It is preferable that the storage appliance runs a self diagnostic during each of its “sessions” to ensure the integrity of the backed up data. If any errors are found during the self diagnostic, then a message will be displayed to the user recommending repair or replacement of the storage appliance.

As an additional security feature, it may be desirable to have a password or key associated with the appliance to prevent unauthorized access.

The foregoing is considered as illustrative only of the principles of the invention. Further, since numerous modifications and changes will readily occur to those skilled in the art, it is not desired to limit the invention to the exact processes, components and applications shown and described, and accordingly, all suitable modifications and equivalents may be resorted to, falling within the scope of the invention and the appended claims and their equivalents.

What is claimed is:

1. A method for simply and regularly backing up data files of a predetermined file type by a fully automated single purpose, portable, detachable backup appliance in communication with a source device, the method comprising:
in response to only a single action being performed by a user with respect to the appliance, the appliance sending a request to the source device to identify, independently of the user, any files of the predetermined file type; and for each file identified performing a backup operation comprising:
checking whether the file has previously been stored; and if not previously stored, storing the file on the appliance by creating a copy.

2. The method of claim 1, wherein the method further comprises setting a timer on the computer to perform the backup operation, automatically and without further input by the user, after a predetermined period of time.

3. The method of claim 1 wherein the method further comprises performing at predetermined intervals a self-diagnostic routine without further input by the user.

4. The method of claim 1, wherein the single action comprises connecting the storage appliance to the source device.

5. The method of claim 1, wherein the single action comprises pushing a button on the storage appliance.

6. The method of claim 1, wherein the file type is a single file type selected from the group consisting of: an image file type, a music file type, an email file type, a business application data file type, a digital video file type, an ebook file type, a contacts file type, a calendar file type, a general documents file type, a tasks file type, a settings file type, an application data file type, a bookmarks file type, and a passwords file type.

7. The method of claim 1, wherein the file type is an image file type.

8. The method of claim 1, wherein the file type is a digital photograph image file type.

9. The method of claim 1, wherein the method includes detecting files of the predetermined file type that are attached to or embedded within other files or applications.

10. The method of claim 1, wherein the method further comprises keeping a map on the appliance of drive and directory location indicating the source of each file on the computer.

11. The method of claim 1, wherein the method requires no installation of software on the source device to perform the backup operation.

12. A fully automated, single purpose, portable, detachable backup appliance in communication with a source device for simply and regularly backing up data files of a predetermined file type, comprising:
a module for sending, in response to only a single action being performed by a user with respect to the appliance, a request to the source device to identify, independently of the user, any files of the predetermined file type; and
a backup module for performing a backup operation for each file identified, the operation comprising:
checking whether the file has previously been stored; and
if not previously stored, storing the file on the appliance by creating a copy.

13. The appliance of claim 12, wherein the appliance comprises a single-purpose storage device adapted exclusively for storage of the predetermined file type.

14. The appliance of claim 12, wherein the appliance is reliant upon the power of the source device.

15. The appliance of claim 12, wherein the appliance is powered by AC power.

16. The appliance of claim 12, wherein the appliance is powered by one or more batteries.

17. The appliance of claim 12, wherein the appliance has a form factor adapted for portability.

18. The appliance of claim 12, wherein the appliance has no display.

19. The appliance of claim 12, wherein the appliance has limited user controls.

20. The appliance of claim 12, wherein the communication between the appliance and the source device is wired.

21. The appliance of claim 12, wherein the communication between the appliance and the source device is wireless.

22. The appliance of claim 20, wherein the appliance includes a built-in cable for interface with the source device.

23. The appliance of claim 20, wherein the cable comprises a USB cable.

24. The appliance of claim 20, wherein the cable comprises a Firewire cable.

25. The appliance of claim 12, wherein the appliance is adapted to interface with a single type of source device.

26. The appliance of claim 25, wherein the source device comprises a computer.

27. The appliance of claim 25, wherein the source device comprises a single device with storage capabilities, selected from the group consisting of: a PC, a PVR, a cellphone, a home electronic device, a digital camera,.a PDA, a digital video camera, a scanner, a digital music player, a digital video player, a game console, and a storage file server.
